(19) United States
(12) Patent Application Publication
(10) Pub. No.: US 2006/0137552 A1
(43) Pub. Date: Jun. 29, 2006

(54) Printing machine comprising a blow air unit for drying stock

(76) Inventors: Udo Pyka, Lengerich (DE); Guenter Rogge, Lienen (DE)

Correspondence Address: JACOBSON HOLMAN PLLC, 400 SEVENTH STREET N.W., SUITE 600, WASHINGTON, DC, 20004, US

(21) Appl. No.: 10/543,925

(22) PCT Filed: Jan. 9, 2004
(86) PCT No.: PCT/EP04/00146

§ 371 Date: Aug. 1, 2005

(30) Foreign Application Priority Data
Feb. 14, 2003 (DE) 103 06 614.4

(51) Int. Cl. B41F 35/00

(52) U.S. Cl. 101/424.1

(57) ABSTRACT

The invention relates to a printing machine, preferably a rotation printing machine, with at least one guide roller (14), which is mounted between two side frames (7, 8). A printing substrate can be guided via the guide roller and at least one print roller can be placed on the guide roller. The printing machine has at least one blast air unit (2) that is arranged in the rotation direction of the guide roller (14) behind the print roller. The blast air unit (2) blows out blast air on the substrate that can be inserted into and removed from its working position. The blast air unit (2) comprises inlet and outlet openings (29, 30) that can be connected to frame-fixed air inlets (10) and air vents (11) wherein the air inlets (10) and the air vents (11) and/or the inlet and outlet openings (29, 30) are bordered by sealings (26, 28). The printing machine is characterized in that, the blast air unit (2) can be moved during the insertion process in two directions that are independent of one another.

The invention relates to a printing machine according to the generic term of claim 1.

In order to be able to observe the print images behind the individual printing units, particularly in the print proof, it is necessary to temporarily move the blast air units from their working positions in the printing machine since they conceal the view of the printing substrate if they are placed tightly against a roller guiding the printing substrate, for instance, an impression cylinder. Furthermore, the blast air units on which and in which fine ink spray and other dirt particles can get deposited during the printing operation can be removed for cleaning purposes.

In a device known from DE 199 93 607 A1 of the aforementioned type, the blast air unit can be moved away from the impression cylinder in a substantially radial direction and can be placed against it again by guiding the blast air unit via slides or carriages in frame-fixed guides. In order to connect the blast device to the lines supplying and discharging the blast air, the blast air unit is provided with coupling pieces that can be coupled to the lines, each of which is accommodated in a side frame. The connection pieces of the blast air unit and the air inlets and the air vents of the lines supplying and discharging the blast air have sealing rings comprising elastomer material for the purpose of a sealed connection. Since the sealings rub against one another each time the blast air unit is moved away and moved back, the sealing effect reduces after a short while.

Therefore, the task of the invention is to create a printing machine of the aforementioned type in which it is possible, even after longer periods of time, to create a very tight-connection between the inlet and outlet openings of the blast air unit and the air inlets and air vents.

The task is solved by the features specified in the characteristics of claim 1.

According to this, the blast air unit can be moved during the insertion process in two directions that are independent of one another. These movement options make it possible to bring the blast air unit firstly close to the printing substrate guided on the guide roller, without the sealings located on the lines or the air inlets and air vents contacting one another. Independent of this movement, the blast air unit can additionally be moved in such a manner that the sealings attached to the blast air unit and/or its openings are pressed on the sealings of the air inlets and air vents without the sealings rubbing against one another. Of course these movements can be reversed in order to separate the blast air unit from the air inlets and the air vents and in order to be able to move away the blast air unit from the guide roller for the purpose of observing the printing substrate.

In doing do, it is advantageous firstly if the blast air unit can be moved in one direction in such a manner that subsequently the inlet opening with the air inlet and the outlet opening with the air vent lie on the same alignment axis and secondly if the blast air unit can be moved in a second direction that runs parallel to the alignment axes. Such directions of movement make it possible to displace the blast air unit first in the direction of the printing substrate and subsequently displace the blast air unit in the second direction so as to create a tight connection between the blast air unit and the air inlets and air vents, without loading the sealings with shear stresses. For this purpose however, both the directions of movement are not required to be orthogonal to one another.

In a preferred embodiment of the invention, the blast air unit can be moved in the second direction running parallel to the alignment axes via force application and/or transfer means. Since the sealings comprise elastomer material, they exert a reset force if pressed together. This force must be overcome during the displacement of the blast air unit for which a force application and/or transfer means is provided. If the sealings are separated from one another the adhesive forces frequently prevent a complete separation requiring the application of forces even in this case. The force application means can provide the force, for instance, by energy conversion such as in an electric motor. However, even magnetic forces can be used for the said purpose. An example of force transferring means can be piston cylinder units that provide the pressure of compressed air directly as mechanical force.

In an additional embodiment of the invention, the force provided by the force application and/or transfer means can be fed into a support means. In this manner the force provided or acting at another point can be supplied to a desired point of action. An example of such support means can be threaded rods that execute, using the available force via spindle nuts, a linear movement with respect to the spindle nuts.

In a particularly preferred embodiment of the invention, at least during the displacement of the blast air unit in the second direction running parallel to the alignment axes, the support means are connected to a component providing a counteracting force. The support means thus affects the movement of the blast air unit with respect to the air inlets and air vents. If the blast air unit is in its working position, the connection can remain intact so that the connection between the sealings cannot be detached unintentionally. The force application and/or transfer means, the support means and also the components providing the counteracting force can be attached to the air inlets and air vents.

However, it is advantageous if the force application and/or transfer means are mounted on the blast air unit.

In a preferred embodiment, the force application and/or transfer means are a clamping lever and/or a springy element. The clamping lever can be used to bring the blast air unit into its working position. Simultaneously, the applied force can be used to stress a springy element, for example a pressure spring, and its energy can be used later in order to separate the connection of the blast air unit to the air inlets and air vents reliably again.

In an advantageous embodiment of the invention, the support means comprise at least one bolt running substantially parallel to the alignment axes.

The bolt is advantageously mounted on the blast air unit such that it can be displaced. Due to this measure the clamping lever, the springy element and the bolt form a functional unit. Using the clamping lever the bolt can be pushed away from the blast air unit. Using the force of the spring acting in opposition, the bolt can then be attached again since the counteracting force acts on the bolt at the same time. The blast air unit can be moved by activating the clamping lever.

In another advantageous embodiment of the invention, the component providing a counteracting force is a centering piece and/or a hook attached to a side frame. In order to be set below the hook, the bolt can carry a disk on its end that is turned toward the side frame. The advantage of a centering piece is that the blast air unit, during the movement in the second direction running parallel to the alignment axes, only executes a movement in the first direction of movement that is independent of it and not accidentally.

In another embodiment of the invention, the support means can be fixed after reaching the working position of the blast air unit. The support means can be fixed, for example, using the clamping lever that can be provided for this purpose with a depression.

A particularly preferred embodiment of the invention is explained in the following description and on the drawings.

The individual figures illustrate:

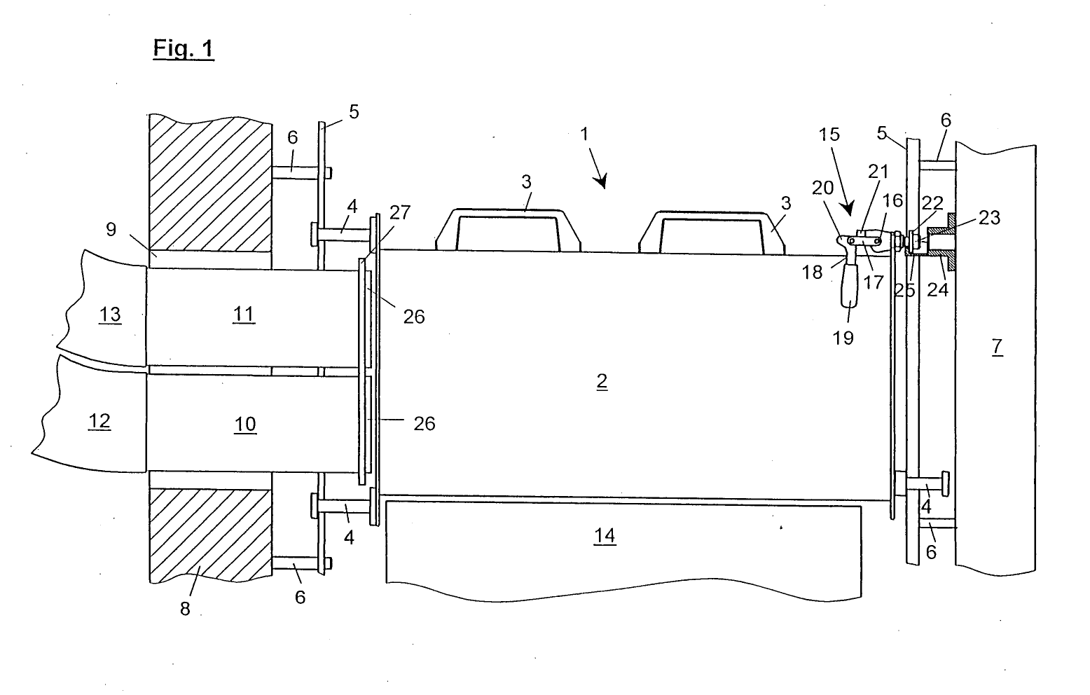

FIG. 1 blast air unit of a printing machine according to the invention in a position in which it is moved away from the supply and discharge lines.

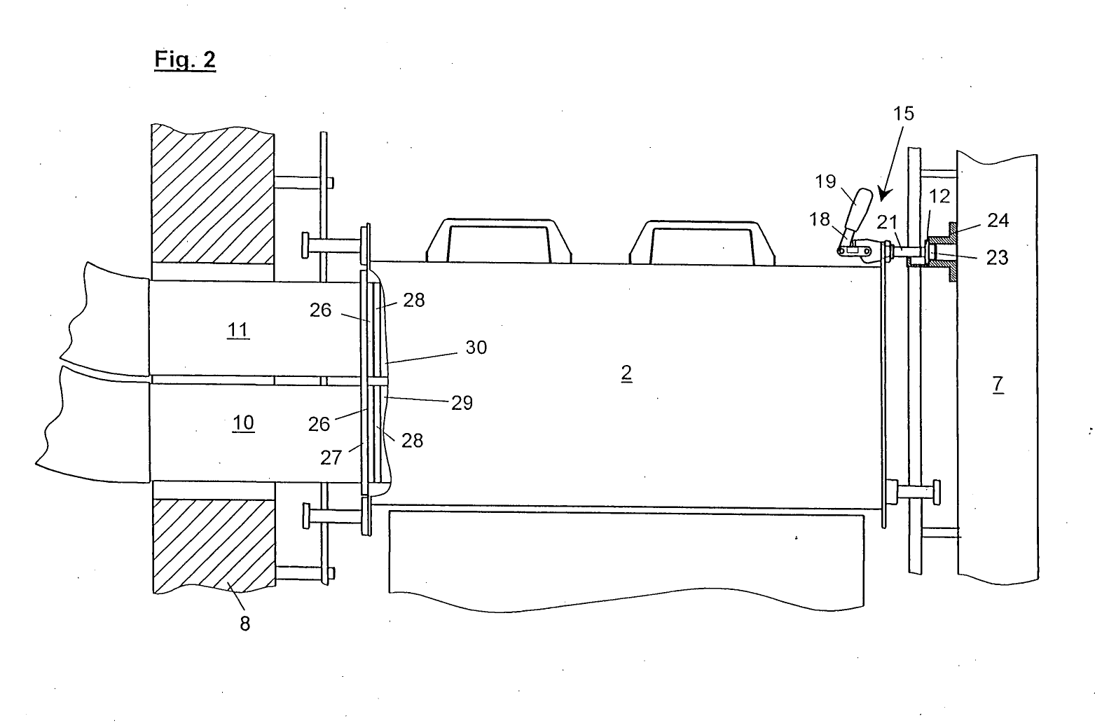

FIG. 2 blast air unit of a printing machine according to the invention in its working position.

FIG. 1 illustrates a section of a printing machine according to the invention. This section represents the drying station 1 comprising the blast air unit 2. In order to be able to move the blast air unit toward and away again from the impression cylinder 14, hand grips 3 are attached to the blast air unit 2. On the lateral front walls of the blast air unit 2 are rolls 4 with which the blast air unit is supported on guide rails 5. The guide rails 5 are attached with stud bolts 6 to the side frames 7, 8. The side frame 8 is provided with an opening 9 through which the air inlet 10 and the air vent 11 pass. Both connection pieces 10, 11 are attached to the side frame 8 in a manner that is not illustrated in the figure. The air inlet 10 is connected via a supply air hose 12 to a blast air supply. The exhaust air concentrated with solvents is discharged via air vents 11 and an exhaust air hose 13. The air inlets and air vents 10, 11 are connected to a counter hold sheet plate on their side that is opposite to the hoses 12, 13. Sealings 26 are attached on these ends of the air inlets and air vents.

A quick clamping unit is attached to the side of the blast air unit 2 that is turned toward the side frame 7. The bolt 21 is displaceably mounted in a guide 16. Inside this guide 16, a pressure spring that is not illustrated in the figure acts on the bolt 21 in such a manner that the bolt constantly experiences a force in the direction of the lever 18. The lever 18 is also connected using a bar 17 to the guide 16 so that the range of the movement of the bolt 21 is limited.

In this initial position of the bolt 21, a disk 22 that is attached to the end of the bolt that is turned toward the side frame 7 sets in place below the hook 25 that is connected via a receptacle 24 firmly to the side frame 7. The reset force of the pressure spring together with the hook 25 causes a relative movement of the blast air unit in the direction of the side frame 7 wherein the movement range is determined by the bar 17 in such a manner that the blast air unit 2 does not contact the sealings 26 any more.

If a tight connection is created between the air inlets and air vents 10, 11 and the blast air unit 2, then the blast air unit 2 must be moved in the direction of the side frame 8. For this purpose the lever 18 is equipped with an eccentric 20. If the lever 18 is turned over via the hand grip 19 by the operating personnel, the eccentric 20 presses the bolt 21 in the direction of the side frame 7. The centering piece 23, attached to the bolt 21, is set in a borehole of the receptacle 24. After a short idle run, the disk 22 bears on the receptacle 24 so that the bolt 21 can no longer move with respect to the side frame 7. If the lever 18 is further activated, the blast air unit 2 moves in the direction of the side frame 8 so that the blast air unit 2 finally reaches its working position.

In this working position, the blast air unit 2 rests against the counter hold sheet plate 27. This position is illustrated in FIG. 2. In doing so the sealings 26 are pressed against the counter sealings 28 that border the inlet opening 29 and the outlet opening of the blast air unit 2. In the working position, the lever 18 is turned over in such a manner that the reset force of the spring presses the bolt 21 into the depression between the eccentric 20 and the lever 18. The unintentional detachment of the lever 18 is thus prevented.

List of reference symbols

| | |
|---|---|
| 1 | Drying station |
| 2 | Blast air unit |
| 3 | Hand grip |
| 4 | Rolls |
| 5 | Guide rail |
| 6 | Stud bolt |
| 7 | Side frame |
| 8 | Side frame |
| 9 | Opening |
| 10 | Air inlet |
| 11 | Air vent |
| 12 | Supply air hose |
| 13 | Exhaust air hose |
| 14 | Impression cylinder |
| 15 | Quick clamping unit |
| 16 | Guide |
| 17 | Bar |
| 18 | Lever |
| 19 | Hand grip |
| 20 | Eccentric |
| 21 | Bolt |
| 22 | Disk |
| 23 | Centering piece |
| 24 | Receptacle (retainer) |
| 25 | Hook |
| 26 | Sealings |
| 27 | Counter hold sheet metal |
| 28 | Counter sealing |
| 29 | Inlet opening |
| 30 | Outlet opening |

1. Printing machine, preferably a rotation printing machine with at least one guide roller (14), which is mounted between two side frames (7, 8). A printing substrate can be guided via the guide roller and at least one print roller can be placed on the guide roller. The printing machine has at least one blast air unit (2) that is arranged in the rotation direction of the guide roller (14) behind the print roller. The blast air unit (2) blows out blast air on the substrate that can be inserted into and removed from its working position. The blast air unit comprises inlet and outlet openings (29, 30) that can be connected to frame-fixed air inlets (10) and air vents (11) wherein the air inlets (10) and the air vents (11) and/or the inlet and outlet openings (29, 30) are bordered by sealings (26, 28). The printing machine is
characterized in that
the blast air unit (2) can be moved during the insertion process in two directions that are independent of one another.

2. Printing machine according to claim 1,
characterized in that
the blast air unit (2) can firstly be moved during the insertion process in one direction in such a manner that the inlet opening (29) with the air inlet (10) and the outlet opening (30) with the air vent (11) each lie on the same alignment axes, and secondly in a second direction that runs parallel to the alignment axes.

3. Printing machine according to claim 2,
characterized in that
the blast air unit (2) can be moved in the second direction that runs parallel to the alignment axes via force application and/or transfer means (15, 17, 18, 19).

4. Printing machine according to claim 3
characterized in that
the force provided by the said force application and/or transfer means (15, 17, 18, 19) is fed into support means (21, 22, 23).

5. Printing machine according to claim 4,
characterized in that
the support means (21, 22, 23) are connected at least during the displacement of the blast air unit (2) in the second direction running parallel to the alignment axes to a component (24, 25) providing a counteracting force.

6. Printing machine according to claim 3,
characterized in that
the force application and/or transfer means (15, 17, 18, 19) are supported on the blast air unit (2).

7. Printing machine according to claim 3,
characterized in that
the force application and/or transfer means is a clamping lever (15, 17, 18, 19) and/or a springy element.

8. Printing machine according to claim 3,
characterized in that
the support means comprise at least one bolt (21, 22) that is substantially aligned parallel to the alignment axes.

9. Printing machine according to claim 8,
characterized in that
the bolt (21, 22) is displaceably mounted on the blast air unit (2).

10. Printing machine according to claim 3,
characterized in that
a component providing the counteracting force is a centering piece (24) that is attached to a side frame (7, 8) and/or a hook (25).

11. Printing machine according to claim 3,
characterized in that
the support means (21, 22) can be fixed after reaching the working position of the blast air unit (2).

12. Process for inserting a blast air unit (2) in its working position in a printing machine wherein the blast air unit (2) in its working position applies blast air on a printing substrate that is guided on a guide roller (14) and just printed and wherein the blast air unit (2) comprises inlet and outlet openings (29, 30) that are bordered
with sealings (28) and connected to frame-fixed air inlets and air vents (10, 11) that are also bordered with sealings (26). The process is
characterized in that
the blast air unit (2) is moved during the insertion process in two directions that are independent of one another.

13. Process according to claim 12,
characterized in that
the blast air unit (2) can firstly be moved during the insertion process in one direction in such a manner that the inlet opening (29) aligns with the air inlet (10) and the outlet opening (30) with the air vent (11) and that the blast air unit (2) is moved in a second direction that runs parallel to the alignment axes.
